(19) United States
(12) Patent Application Publication
(10) Pub. No.: US 2024/0383143 A1
(43) Pub. Date: Nov. 21, 2024

(54) AFFORDANCE-DRIVEN MODULAR REINFORCEMENT LEARNING

(71) Applicant: QUALCOMM Incorporated, San Diego, CA (US)

(72) Inventors: Pietro MAZZAGLIA, Ghent (BE); Taco Sebastiaan COHEN, Amsterdam (NL); Daniel Hendricus Franciscus DIJKMAN, Haarlem (NL)

(21) Appl. No.: 18/391,129

(22) Filed: Dec. 20, 2023

Related U.S. Application Data
(60) Provisional application No. 63/502,752, filed on May 17, 2023.

(51) Int. Cl. B25J 9/16

(52) U.S. Cl. CPC B25J 9/1669; B25J 9/163

(57) ABSTRACT

Certain aspects of the present disclosure provide techniques and apparatus for improved machine learning. Sensor data depicting a physical environment is accessed, and a set of output affordance maps is generated based on processing the sensor data using an ensemble machine learning model, where each respective output affordance map of the set of output affordance maps indicates a respective probability that a first action can be performed at at least a first location in the physical environment using a respective set of action parameters. Based on the set of output affordance maps, a first set of action parameters and the first location are selected. The first action is performed at the first location in accordance with the first set of action parameters.

### CROSS REFERENCE TO RELATED APPLICATION(S)

The present application for patent claims the benefit of priority to U.S. Provisional Appl. No. 63/502,752, filed May 17, 2023, which is hereby incorporated by reference herein in its entirety.

### INTRODUCTION

Aspects of the present disclosure relate to machine learning.

Robotic systems are used to perform a wide variety of tasks today. Additionally, the use of robots has increased substantially, and is expected to continue to increase. For example, robotic arms can be used to manipulate and move objects or to perform other actions, such as on a vehicle assembly line. As the desired tasks have expanded, the robotic control systems have similarly grown increasingly complex. Beyond controlling the positioning of robotic manipulators with high accuracy (which may include not only positioning and/or orientation of any end effectors such as graspers, but also of the other components of the arm itself), control systems may also obtain and use information about their environment. For example, before a robotic arm can be used to pick up objects in some cases, the control system may first determine environmental context, such as where the objects are, how the objects are positioned/oriented, how the objects can be lifted, and/or the like.

Machine learning has revolutionized many fields and systems, including some aspects of robotics. However, dynamically controlling robotic systems based on the surrounding environment remains a highly difficult problem, even with advantages provided by some conventional machine learning solutions.

### BRIEF SUMMARY

Certain aspects of the present disclosure provide a processor-implemented method, comprising: accessing sensor data depicting a physical environment; generating a set of output affordance maps based on processing the sensor data using an ensemble machine learning model, wherein each respective output affordance map of the set of output affordance maps indicates a respective probability that a first action can be performed at at least a first location in the physical environment using a respective set of action parameters; selecting, based on the set of output affordance maps, a first set of action parameters and the first location; and performing the first action at the first location in accordance with the first set of action parameters.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example environment for training and using machine learning models to control robotic systems.

FIG. 2 depicts an example architecture for generating affordance maps.

FIG. 3 depicts an example architecture for generating affordance maps and uncertainty maps.

FIG. 4 is a flow diagram depicting an example method for selecting and performing actions using machine learning.

FIG. 5 is a flow diagram depicting an example method for generating affordance maps.

FIG. 6 is a flow diagram depicting an example method for selecting and performing actions using machine learning.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing affordance-based reinforcement learning to improve action selection and performance, such as using robotic manipulators.

As used herein, “affordances” refer to action possibilities that an actor or agent can perform in an environment. For example, in an environment with one or more objects located nearby, affordances (e.g., actions that can be performed) might include picking up an object, placing an object atop another object, sliding an object to a new spot, rotating an object, and the like. In some aspects of the present disclosure, robotic manipulators (e.g., robotic arms) are used as an example technology that can be improved or controlled using the techniques described herein. Specifically, in some aspects, grasping is used as an example action that a robotic manipulator can perform. However, aspects of the present disclosure are applicable to a wide variety of actions-such as pushing, pulling, placing objects on top of each other, inserting objects into other objects, extracting objects from within other objects, turning objects, and the like—which a robot may be capable of performing. Further, aspects of the present disclosure are applicable to a wide variety of non-robot technologies and solutions, including simulation or control of virtual entities (e.g., simulated robots) or other physical or virtual agents.

In some aspects, sensor data from the environment is collected and evaluated using machine learning to generate or select an action, and a robotic manipulator is controlled to perform the action (or to attempt to perform the action). As used herein, “performing” an action may include successfully performing the action (e.g., picking up an object) as well as unsuccessfully performing the action (e.g., dropping an object or failing to grasp the object entirely). In some aspects, during a training or exploration phase, actions that may maximize (or at least increase) learning potential are selected, and the resulting action success or outcome can be evaluated to refine the models. In some aspects, during an inferencing or robustness phase, actions that maximize (or at least increase) probability of success and/or minimize (or at least reduce) uncertainty may be selected. In some aspects, during the inferencing phase, the system may continue to monitor the action success or outcome to further refine the models.

In some aspects, the content and format of the evaluated sensor data may vary depending on the particular implementation and may include a variety of data such as, but not limited to, image data (e.g., captured using one or more imaging sensors), information about the robot's internal state (e.g., pose, velocity, force, grasp detection, what tool or end effector the robot is using, and the like), point cloud data (e.g., from light detection and ranging (LIDAR) or other depth sensors), radar data (which may include point cloud data, 3D volume heatmaps, and the like), ultrasonic data, and the like.

In some aspects, machine learning models can be trained based on knowledge of the robot control itself (e.g., the system knows how to move the robotic manipulators to desired positions and orientations), without previous knowledge of the environment or objects (e.g., with no pre-training or other such knowledge).

In some aspects, machine learning models are trained to identify and score the robot's affordances, which correspond to actions the robot (also referred to in some aspects as an agent) can perform in the environment. For example, given an image of the scene (including one or more objects), the models may generate affordance map(s) indicating, for each pixel or depicted location, the probability that a “grasp” action can be successfully completed (e.g., the probability that the robot would be successful in picking up the object if the robot grasped the object at the given location using one or more specific parameters, such as a defined grasper orientation).

In this way, by allowing the system to explore and attempt to complete actions, the models can be trained based on (automated) experimentation rather than active labeling or manual effort. This can substantially improve model robustness, as well as substantially reducing the costs and delays of training the model(s) and/or deploying the robot to a new position or otherwise changing the environment or objects with which the robot interacts.

### Example Environment for Training and Using Machine Learning Models to Control Robotic Systems

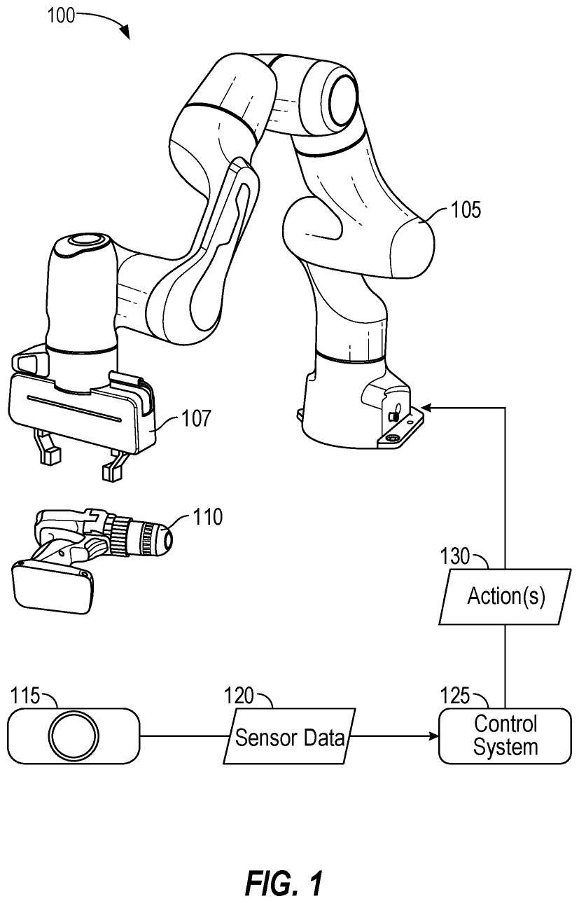

FIG. 1 depicts an example environment 100 for training and using machine learning models to control robotic systems.

In the illustrated example, a robotic arm 105 equipped with a robotic grasper end effector 107 is in an environment with one or more objects 110. In the illustrated environment 100, one or more sensors 115 are used to collect sensor data 120 for a space in the environment 100. For example, in some aspects, the sensor 115 includes an imaging sensor, such as a red-green-blue-depth (RGB-D) imaging sensor. In some aspects, one or more of the sensors 115 are configured to capture data (e.g., images) of the scene, which may include the objects 110 present, the robotic arm 105, and/or the end effector 107 itself. In some aspects, the sensor data 120 is collected continuously or periodically (e.g., several times per second) and evaluated by a control system 125 to generate actions 130. As described above, the actions 130 may include any suitable action which a robot may be capable of performing, such as, but not limited to, grasping, pushing, pulling, placing objects on top of each other, inserting objects into other objects, extracting objects from within other objects, turning objects, and the like.

In some aspects, the control system 125 evaluates the sensor data 120 to predict which parts of the scene or the objects 110 are graspable by the robot (e.g., which objects can be grasped and moved by the robot and/or which part(s) of a given object are graspable), as well as how the object(s) or portion(s) thereof should be grasped (e.g., what orientation of the end effector 107 and/or what point or location on the object should be grasped).

In some aspects, as discussed below in more detail, a deep learning solution (e.g., a convolutional-neural-network-based solution) is used by the control system 125, based on interactive learning and/or uncertainty minimization (or at least reduction). As discussed below in more detail, the control system 125 chooses both a location to grasp in the environment as well as one or more action parameters (e.g., an angle or orientation of the end effector 107 to specify the grasping direction). As used herein, the action parameters can generally correspond to or include a wide variety of parameters, depending on the particular implementation and/or action. For example, the action parameters may include an action orientation (e.g., the orientation of the end effector 107 or other entity), an action force (e.g., how much force the robotic arm 105 should apply on the object, such as via the grasper (e.g., how tightly to grasp) and/or how much force to apply to push or move the object), an action direction (e.g., which direction the robotic arm 105 should move during the action, such as which direction to push, pull, or turn the object), and the like.

In the illustrated example, the control system 125 selects one or more actions 130 based on evaluating the sensor data 120 using one or more machine learning models. For example, the action(s) 130 may indicate a specific set of action parameters (e.g., an orientation of the end effector 107) and a specific location in the scene (e.g., where on the object 110 the robotic arm 105 should grasp). The robotic arm 105 and/or the end effector 107 can then be driven to the indicated location for grasping at the specified orientation, and the end effector 107 attempts to grasp the object (or perform some other action). In some aspects, in order to refine or update the models, the success of the attempt can be determined by the one or more sensors 115 (e.g., load cell sensors, imaging sensors, and the like).

In some aspects, the control system 125 can thereby be used to repeatedly generate the action(s) 130 for the robotic arm 105, observing the results and refining the models. After experimentation (e.g., attempting to perform the action some number of times), the models can be used to provide robust and accurate actions with a high success rate.

In some aspects, the control system 125 may perform both model training (e.g., during an exploration phase) as well as runtime inferencing (e.g., during a robustness phase). In other aspects, the model(s) may be trained by one or more other systems before being deployed to the control system 125 (or the control system 125 may train the model(s) before deploying the model(s) to other inferencing system(s)).

### Example Architecture for Generating Affordance Maps

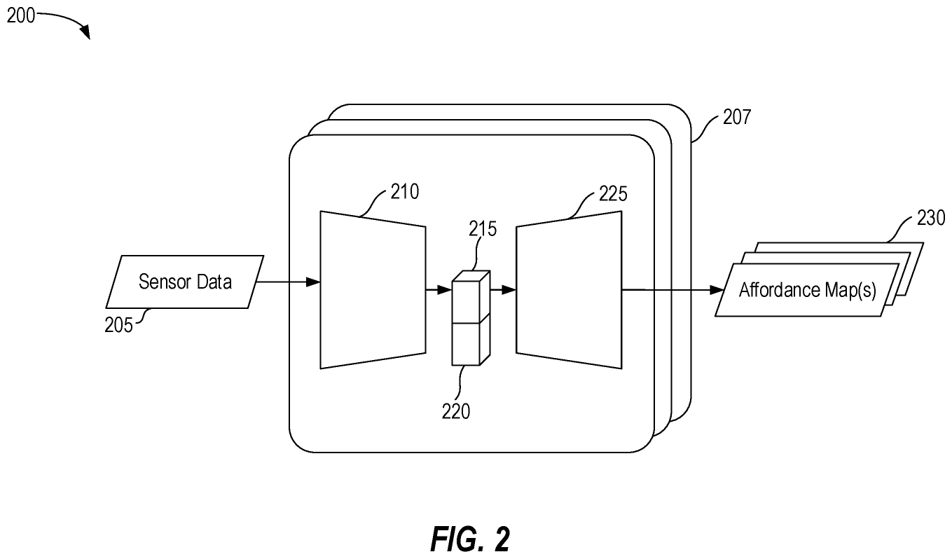

FIG. 2 depicts an example architecture 200 for generating affordance maps. In some aspects, the architecture 200 is used by a control system, such as the control system 125, to train the model(s) and/or to generate affordance maps that drive action selection, as discussed in more detail below.

In the illustrated example, sensor data 205 (which may correspond to the sensor data 120 of FIG. 1) is evaluated by a machine learning model 207 (referred to in some aspects as an affordance model) to generate affordance maps 230. In some aspects, the machine learning model 207 is an ensemble (e.g., a combination of multiple models) of deep learning models (e.g., convolution-based models). In some aspects, the input sensor data 205 is collected and/or received from a camera (e.g., the sensor data may indicate the color and/or depth of each pixel in an image).

In the illustrated example, the machine learning model 207 includes one or more encoders 210 and one or more decoders 225. In some aspects, if the machine learning model 207 is an ensemble, then each encoder and decoder pair may correspond to a single model within the ensemble. That is, there may be multiple models, each including a corresponding encoder 210 and decoder 225, in the machine learning model 207. In some aspects, a single shared encoder 210 may be used in combination with a set of multiple decoders 225 in the ensemble.

In some aspects, the machine learning model 207 (or each branch thereof) is implemented as a U-Net. For example, the encoder 210 may comprise or correspond to one or more convolutions and/or downsampling operations, while the decoder 225 may comprise or correspond to one or more corresponding convolutions and/or upsampling operations. In some aspects, one or more skip connections may also be used to directly provide intermediate features (generated by the encoder 210) as input to one or more operations of the decoder 225.

As illustrated, each encoder 210 generates a latent tensor 215 based on the input sensor data 205. For example, as discussed above, the encoder 210 may process the sensor data 205 using one or more convolution layers to extract salient features and generate the latent tensor 215. In the illustrated example, in this latent space, an action parameter tensor 220 can be combined with the latent tensor 215. For example, the action parameter tensor 220 may be appended to or concatenated with the latent tensor 215, added to the latent tensor (e.g., via element-wise addition), and the like.

In some aspects, the action parameter tensor 220 may generally encode one or more action parameters for performing the action, as discussed above. For example, the action parameter tensor 220 may encode the grasping orientation to be used. In some aspects, the control system generates multiple combined or aggregated latent tensors using a multiple action parameter tensor 220. For example, for each respective combination of action parameter values, the control system may generate a corresponding aggregated latent tensor (including both the latent tensor 215 and a respective action parameter tensor 220).

As one example, for categorical action parameters (e.g., whether to push or pull an object, whether to rotate the object left or right, and the like), the action parameter tensor 220 may encode a specific combination or set of categories (e.g., a first set of action parameters indicating to rotate the object to the right while pushing the object, a second set indicating to rotate the object to the right while pulling the object, a third set indicating to rotate the object to the left while pushing the object, and a fourth set indicating to rotate the object to the left while pulling the object).

As another example, in some aspects, continuous action parameters (e.g., grasp orientation, action force, and the like) may be discretized into a set of categories or values, and the action parameter tensor 220 may encode a specific combination for such categories or values. For example, the orientation and force options may be discretized into some number (e.g., five hundred) of possible orientations and/or forces.

In this way, the control system may use a single latent tensor 215 to generate a larger number of aggregated latent tensors by combining a copy or instance of the single latent tensor 215 with each unique action parameter tensor 220 in turn (in sequence or in parallel).

In the illustrated example, the control system then passes each aggregated latent tensor through a decoder 225 to generate one or more affordance maps 230. As used herein, an “affordance map” is generally a data structure representing the probabilities that one or more locations in an environment correspond possible action(s). For example, an affordance map may indicate, for each location (e.g., each pixel in an image), the probability that one or more actions can be performed at the location (e.g., a grasping action). In some aspects, each decoder 225 generates an affordance map 230 for each aggregated latent tensor. For example, if grasp orientation is the only action parameter and there are three hundred discrete orientations that the control system considers, then three hundred aggregated latent tensors may be generated (based on a single latent tensor 215 if a shared encoder 210 is used, or based on multiple latent tensors if multiple encoders are used), and the decoder 225 may be used to generate three hundred affordance maps 230 (in sequence or in parallel). Additionally, as discussed above, if the machine learning model 207 is an ensemble (e.g., with multiple decoders, each either using a corresponding encoder or using a shared encoder), then each decoder 225 may generate the same number of affordance maps 230. Continuing the above example, if there are five branches or decoders 225 in the machine learning model 207, then each decoder 225 may generate a corresponding set of three hundred affordance maps 230 for a total of fifteen-hundred affordance maps 230 generated based on a single set of input sensor data 205.

Further, if a separate encoder 210 is used for each of the decoders 225, each encoder 210 may be used to generate a corresponding latent tensor 215, each of which may be used to generate a set of aggregated latent tensors. Continuing the above example, if the machine learning model 207 includes five branches (e.g., five encoder-decoder pairs) and the action parameter has three hundred discrete orientations or alternatives, a set of three hundred aggregated latent tensors may be generated for each encoder-decoder pair (resulting in fifteen-hundred aggregated latent tensors), and each aggregated latent tensor may then be processed using a corresponding decoder 225 (e.g., using the decoder 225 that corresponds to the encoder 210 used to generate each given aggregated latent tensor), resulting in fifteen-hundred affordance maps 230.

As each affordance map 230 is generated based on a corresponding set of action parameters (encoded in the action parameter tensor 220), each affordance map thereby corresponds to or indicates a predicted set of success probabilities if the corresponding set of action parameters is used to perform the action. In some aspects, the affordance maps 230 indicate the probability that the given action will be successfully completed for each location or point in the scene (as depicted in the sensor data 205), if the corresponding set of action parameters is used (e.g., the probability that a grasp action will be successful if the end effector is used to grasp at each location). For example, if the sensor data 205 comprises image data, then each affordance map 230 may include a predicted success probability for each pixel (or other logical portion) of the image, indicating the probability that the action will be successful if the action is performed in accordance with the corresponding action parameter(s) at the physical location that corresponds to or is depicted by the pixel.

In some aspects, the affordance maps 230 can be collectively thought of as maps of Bernoulli distributions, one per each point or pixel in the input data. That is, each decoder 225 in the ensemble generates a corresponding affordance map 230 for each set of action parameters. Accordingly, for each location (e.g., each pixel), there may be multiple predicted success probabilities for each set of action parameters (one generated by each decoder 225).

In some aspects, during training, the control system explores uncertainty in grasping points and orientations (or other action parameters), as discussed in more detail below. This can allow the control system to rapidly learn (e.g., to update the parameters of the decoder(s) 225 and encoder(s) 210. In some aspects, during runtime (when robustness is desired), the control system may evaluate the affordance maps 230 to identify the specific action (e.g., a specific location and grasp orientation) that results in the highest probability of success.

### Example Architecture for Generating Affordance Maps and Uncertainty Maps

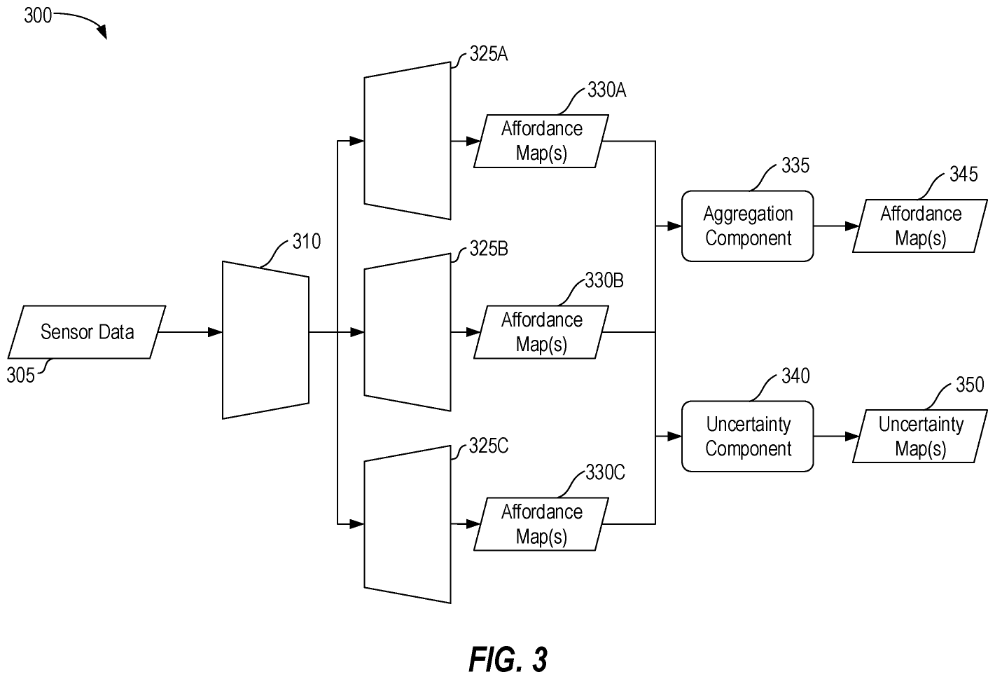

FIG. 3 depicts an example architecture 300 for generating affordance maps and uncertainty maps. In some aspects, the architecture 300 is used by a control system, such as the control system 125, to train the model(s) and/or to generate affordance maps that drive action selection, as discussed in more detail below. In some aspects, the architecture 300 provides additional detail for the architecture 200 of FIG. 2. In the illustrated example, sensor data 305 (which may correspond to the sensor data 120 of FIG. 1 and/or the sensor data 205 of FIG. 2) is evaluated to generate affordance maps 345 (which may correspond to affordance maps 230 of FIG. 2) and uncertainty maps 350.

In the illustrated example, the sensor data 305 is processed by an encoder 310 (which may correspond to the encoder 210 of FIG. 2) to generate a latent tensor, which is combined with one or more action parameter tensors and is processed by a set of decoders 325A-C (collectively, decoders 325), which may correspond to the decoder 225 of FIG. 2. For example, as discussed above, each decoder 325 may correspond to a branch or model of the ensemble. In the illustrated example, a shared encoder 310 is used for each decoder 325. In some aspects, as discussed above, each decoder 325 may have its own corresponding encoder 310. Additionally, though three decoders 325 are depicted, in other aspects, there may be any number of decoders 325 or branches in the model ensemble.

As illustrated, each decoder 325 generates an interim affordance map 330 for each set of action parameters based on the sensor data 305. Specifically, the decoder 325A generates the interim affordance maps 330A, the decoder 325B generates the interim affordance maps 330B, and the decoder 325C generates the interim affordance maps 330C. In some aspects, as discussed above, the interim affordance maps 330 may generally indicate probabilities that an action will be successful if the action is performed at one or more specific locations using one or more specific action parameters (e.g., at a specific point on an object and using a specific grip orientation).

In the illustrated example, the generated interim affordance maps 330 are provided to an aggregation component 335 and an uncertainty component 340. Generally, the aggregation component 335 aggregates the interim affordance maps 330 to generate the output affordance map(s) 345. For example, the aggregation component 335 may perform element-wise summation or averaging. In some aspects, each affordance map 345 may therefore include action success probabilities determined based on the collective predictions contained within each interim affordance map 330 (e.g., the average probability of success for each pixel). In some aspects, as discussed above, there may be an affordance map 345 for each unique set of possible action parameters for performing the action.

That is, for each respective set of action parameter values (e.g., each action parameter tensor), the aggregation component 335 may identify the corresponding set of interim affordance maps 330 (one generated by each decoder 325) for the set of parameter values, and aggregate this set to generate an output affordance map 345 for the set of action parameter values. In this way, the total number of affordance maps 345 may match the number of unique action parameter value combinations. For example, if there are three hundred unique options, then the aggregation component 335 may generate three hundred output affordance maps 345, one for each option.

In the illustrated example, the uncertainty component 340 generates a set of uncertainty maps 350 based on the interim affordance maps 330. In some aspects, the uncertainty maps 350 indicate the uncertainty of the model with respect to the affordance maps. For example, if the predicted probability of success for a single point varies substantially between interim affordance maps 330A, 330B, and 330C, then the uncertainty component 340 may determine that uncertainty is high for the single point. In some aspects, the uncertainty maps 350 are generated using a Jensen-Shannon Divergence (JSD) approach (also referred to in some aspects as the information radius).

In some aspects, a respective uncertainty map 350 is generated for each set of action parameters. That is, for each respective set of action parameter values (e.g., each action parameter tensor), the uncertainty component 340 may identify the corresponding set of interim affordance maps 330 (one generated by each decoder 325) for the set of parameter values, and evaluate this set to generate the uncertainty map 350 for the set of action parameter values, indicating the success uncertainty at each location if the set of action parameter values is used. In this way, the total number of uncertainty maps 350 may match the number of unique action parameter value combinations. For example, if there are three hundred unique options, then the uncertainty component 340 may generate three hundred output uncertainty maps 350, one for each option.

In some aspects, the uncertainty value for each point (e.g., each pixel) may be defined using Equation 1 below, where u(s, a) is the uncertainty value for a given state s (e.g., the state of the robot and/or environment, such as for a given location or pixel in the input) and set of action parameters a, JSD(⋅) is the JSD function, p(g|s, a) is the probability of successfully performing the action g with the action parameters a in state S (e.g., at a given location in the environment), and θ is a set of parameters sampled from the set of ensemble parameters Θ (where θ corresponds to the parameters of a specific model or branch of the ensemble, such as a single decoder 325):

$$\begin{matrix}u ( s , a ) = JSD ( p ( g \vert s , a , θ ) \vert θ ∼ Θ ) ) \\ == H ( {𝔼}_{θ ∼ Θ} [ p ( g \vert s , a , θ ) ] ) - {𝔼}_{θ ∼ Θ} [ H ( p ( g \vert s , a , θ ) ) ]\end{matrix} \qquad ( 1 )$$

That is, the uncertainty may be defined as the entropy (H) of the expected ( [symbol] ) probability of success (e.g., the mean probability across the interim affordance maps 330 for the set of action parameters), minus the expected entropy of the predicted probabilities of success. In this way, the uncertainty component 340 can generate a respective uncertainty map 350 for each respective set of action parameters, indicating the model uncertainty with respect to each location in the space (e.g., for each pixel in image data) and with respect to each set of action parameters.

In some aspects, these uncertainty maps 350 may be used during training and/or during inferencing. For example, during training, the control system may use the affordance maps 345 and uncertainty maps 350 to select an action that maximizes (or at least increases) predicted success while also maximizing (or at least increasing) uncertainty in order to learn more rapidly. During inferencing (when maximum robustness is desired), the control system may select an action that maximizes, or at least increases, predicted success. In some aspects, in addition to maximizing predicted success, the control system may also seek to minimize, or at least reduce, the uncertainty.

In some aspects, during the training or exploration phase, the control system can perform ensemble sampling. For example, for each set of input sensor data 305 (e.g., each time an action is requested or desired), the one member of the ensemble (e.g., one decoder 325) may be selected with at least an element of randomness (e.g., selecting the decoder randomly or pseudo-randomly). In some aspects, the interim affordance maps 330 generated by this selected decoder are the most important or dominant maps (or the only maps) used during this exploration stage for the current input data. For example, rather than using the output affordance maps 345, the control system may use the interim affordance maps 330 generated by the (randomly selected) decoder 325 during exploration. This can make the training process faster by adding noise to the training data to accelerate generalization.

In some aspects, the uncertainty values (reflected in the uncertainty maps 350) may be summed with the probability values of the corresponding interim affordance maps 330 of the selected decoder 325. That is, for each set of action parameter values, the control system may sum the corresponding uncertainty map 350 with the corresponding interim affordance map 330. For example, the control system may perform element-wise summation to add the uncertainty value for each location (e.g., each pixel) with the predicted probability of action success for each location. In some aspects, this summation is performed for each interim affordance map 330 generated by the selected decoder 325 (e.g., for each set of action parameters).

As the uncertainty maps 350 reflect the information radius with respect to performing the action using each configuration of action parameters, the control system can use the uncertainty maps to provide a proxy of the information that can be gained by attempting the action at each location using the indicated set of parameters. By summing affordance probabilities and the uncertainty values, the control system can obtain an upper confidence bound (UCB) for exploration, which can be used to efficiently learn to find new graspable configurations in the scene. In some aspects, at each time step (e.g., for each set of input sensor data 305 or each time an action is requested or desired), the control system can score the possible configurations (e.g., each combination of a location and a set of action parameters) and select the highest-valued configuration (e.g., the location and set of action parameteres having the highest score) to test.

In some aspects, during exploration, the actions are sampled or selected according to Equation 2 below, where r(s, a) is the generated score of a given state s (e.g., a given location) using a given set of action parameters a, and p(g|s, a, θ) is the predicted probability of success for performing the action g with the action parameters a in state s, as generated by the selected portion of the model (e.g., the interim affordance map 330 generated using the decoder 325 that corresponds to parameters θ):

$$r ( s , a ) = p ( g \vert s , a , θ ) + u ( s , a ) \qquad ( 2 )$$

In this way, the control system may generate a respective score for each respective pixel (e.g., for each location depicted by a pixel) in each respective interim affordance map 330 (e.g., for each set of action parameters). In some aspects, the control system then evaluates the generated scores to select the peak or highest score (e.g., the location and set of action parameters having the highest generated value). In this way, during exploration, the control system selects the action based on determining that performing the selected action (e.g., the action at the selected location and using the selected parameters) will maximize (or at least increase) the predicted success while also maximizing (or at least increasing) the uncertainty.

As discussed above, this action may then be performed, and the success of the action can be evaluated to update or refine one or more parameters of the model. In some aspects, as discussed below in more detail, the control system may update a subset of the parameters, rather than all parameters. For example, the control system may only update the parameters of a selected decoder 325, leaving the other decoders unchanged, based on the success of the action. Similarly, in some aspects, the control system may use masked updating (e.g., masked backpropagation) to update only a subset of those parameters of the selected decoder 325, such as by updating only the parameters that correspond to the selected action location (e.g., the parameters used to predict the success probability for the selected pixel(s)), such that parameters corresponding to other locations (e.g., other pixels in the interim affordance map 330) are unchanged.

In some aspects, during evaluation or use (e.g., runtime inferencing), where maximum accuracy may be preferred, the control system may use the average affordance probability map(s) (e.g., the affordance maps 345), obtained by averaging the probability values of the components in the ensemble, to select the best configuration to perform the action (e.g., the location and set of action parameters with the highest predicted probability of success). In some aspects, the control system may optionally incorporate the uncertainty maps 350 into this selection process (e.g., to select the least ambiguous configurations that are most likely to result in success).

In some aspects, during this runtime or robustness phase, the actions are sampled or selected according to Equation 3 below, where r (s, a) is the generated score of a given state s (e.g., a given location) using a given set of action parameters a, p(g|s, a, θ) is the predicted probability of success for performing the action g with the action parameters a in state s, as generated by a specific portion of the model (e.g., the interim affordance map 330 generated using a single decoder 325 that corresponds to parameters θ), and [symbol] _{θ˜Θ} reflects that the expected value (e.g., the average value across the interim affordance maps 330) is evaluated:

$$r ( s , a ) = {𝔼}_{θ ∼ Θ} [ p ( g \vert s , a , θ ) ] - u ( s , a ) \qquad ( 3 )$$

In this way, the control system may generate a respective score for each respective pixel or location in each respective affordance map 345 (e.g., for each set of action parameters). In some aspects, the control system then evaluates the generated scores to select the peak or highest score (e.g., the location and set of action parameters having the highest generated value). In this way, during inference, the control system selects the action based on determining that performing the selected action (e.g., the action at the selected location and using the selected parameters) will maximize, or at least increase, the predicted success while also minimizing, or at least reducing, the uncertainty.

In some aspects, in a similar manner to training, the selected action may then be performed, and the success of the action can be optionally evaluated to update or refine one or more parameters of the model.

### Example Method for Selecting and Performing Actions Using Machine Learning

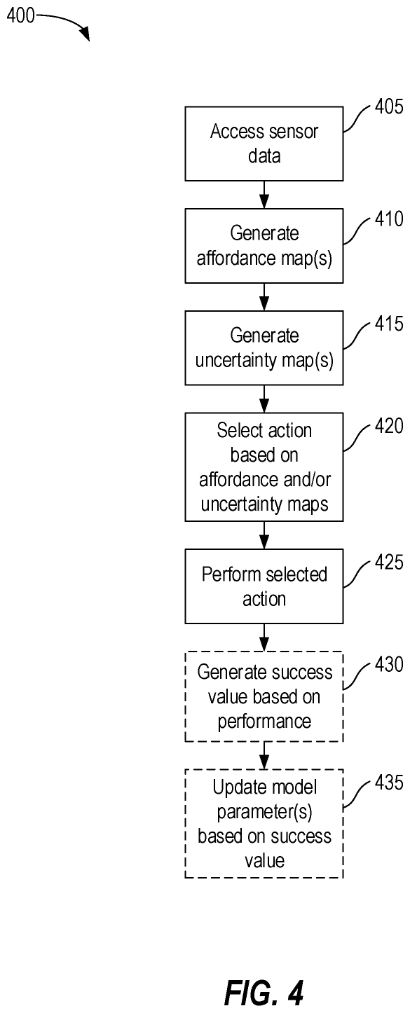

FIG. 4 is a flow diagram depicting an example method 400 for selecting and performing actions using machine learning. In some aspects, the method 400 is performed by a control system, such as the control system 125 of FIG. 1, which may use an architecture for generating affordance maps, such as the architecture 200 of FIG. 2 and/or the architecture 300 of FIG. 3.

At block 405, the control system accesses sensor data (e.g., the sensor data 120 of FIG. 1, the sensor data 205 of FIG. 2, and/or the sensor data 305 of FIG. 3). As used herein, “accessing” data may generally include receiving, requesting, retrieving, collecting, generating, or otherwise gaining access to the data. For example, as discussed above, the control system may access the sensor data continuously or periodically (e.g., every second), or each time an action is desired (e.g., each time the control system or another entity desires to perform the action, such as grasping an object and picking the object up). As discussed above, the sensor data may generally include a wide variety of data, including image data, depth data, point clouds, and the like.

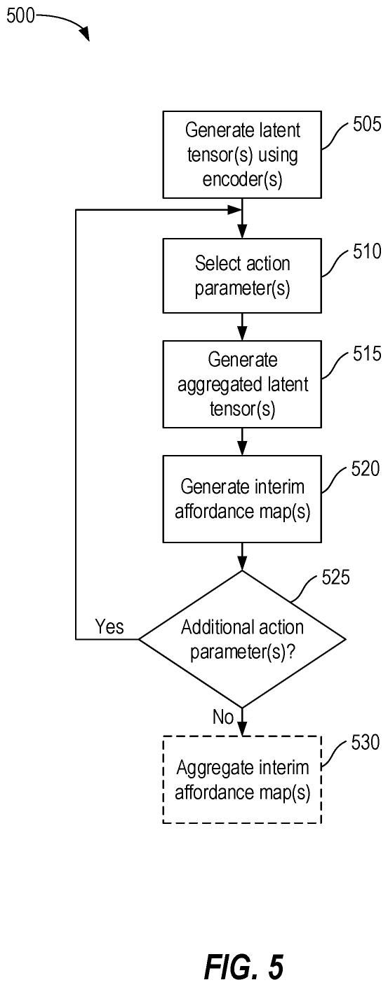

At block 410, the control system generates a set of affordance maps (e.g., the affordance maps 230 of FIG. 2 and/or the affordance maps 345 of FIG. 3) by processing the sensor data using a machine learning model (e.g., an ensemble model), as discussed above. One example of generating the set of affordance maps is described in more detail below with reference to FIG. 5.

At block 415, the control system generates a set of uncertainty maps (e.g., the uncertainty maps 350 of FIG. 3) based on the interim affordance maps, as discussed above. For example, the control system may use Equation 1 to evaluate an uncertainty value for each pixel or location.

At block 420, the control system selects an action based on the affordance maps and/or uncertainty maps. As discussed above, selecting an action may generally include selecting both a point in the space where the action will be performed (e.g., a location on an object depicted by a pixel in the affordance maps) and a set of action parameters (e.g., a grasp orientation, a grip force, and the like). In some aspects, as discussed above, the control system may evaluate the affordance maps and uncertainty maps during exploration (e.g., using Equation 2 above) to select the action. In some aspects, as discussed above, the control system may evaluate only the affordance maps or may evaluate both the affordance maps and the uncertainty maps during runtime use (when robustness is desired), such as using Equation 3 above.

At block 425, the control system can perform the selected action. As used herein, “performing” the action may include transmitting, instructing, or otherwise facilitating performance of the action by another entity, such as a robotic arm. That is, “performing” the action may include instructing a robot (or another system that controls the robot) to perform the indicated action (e.g., to perform the action at the indicated location using the indicated action parameters).

In some aspects, during runtime, the method 400 can then terminate or loop back to block 405 to select the next action. In some aspects, during exploration and/or when the control system is collecting data for potential further training, the method 400 continues to block 430.

At block 430, the control system generates a success value based on the performance of the action. For example, as discussed above, the control system may evaluate one or more sets of sensor data during and/or after performance of the action to evaluate how successful the action was. In some aspects, the success value is a categorical (e.g., binary) value, such as indicating whether the action was performed successfully. In some such aspects, the success criteria used to define whether a given action was successful may be defined based on the particular action. For example, with respect to a grasp action, the success criteria may include considerations such as whether the robot successfully picked up the object, whether the robot was able to lift and hold the object for at least some minimum period of time, whether the robot was able to rotate the object some amount, whether the robot was able to retain grip on the object while shaking or moving the object/end effector, and the like.

In some aspects, the success value is a continuous value indicating the degree of success. For example, the success value may be defined based on the acceleration the robot is able to undergo while maintaining the robot's grasp on the object (e.g., where higher accelerations of the end effector result in higher success scores).

At block 435, the control system updates one or more model parameters of the ensemble model based on the generated success value. In some aspects, as discussed above, the control system may use masked updating (e.g., masked backpropagation in the case of convolutional models) based on the selected location or pixel (where the action was performed), such that other parameters of the ensemble machine learning model corresponding to locations other than the selected location are not updated based on the success value. For example, the control system may generate a loss based on the success value, and mask the loss based on the specific location(s) or pixels (in the affordance map(s)) used to select the action (e.g., where the peak was). This masked loss can then be used to perform a masked backpropagation operation to update the corresponding (relevant) parameters of the model.

Similarly, in some aspects, if a subset of the ensemble model was used (e.g., a single decoder, such as during the exploration phase), the control system updates the parameters of the selected subset (e.g., the selected decoder and encoder), leaving remaining parameters (e.g., parameters of the other decoders) frozen.

Although the illustrated example depicts updating the model parameters based on a single selected action/experiment (e.g., using stochastic gradient descent) for conceptual clarity, in some aspects the control system may update the model based on batches of data (e.g., using batch gradient descent).

In some aspects, during runtime, the method 400 can then terminate or loop back to block 405 to select the next action for new input data.

### Example Method for Generating Affordance Maps

FIG. 5 is a flow diagram depicting an example method 500 for generating affordance maps. In some aspects, the method 500 is performed by a control system, such as the control system 125 of FIG. 1. In some aspects, the method 500 provides additional detail for block 410 of FIG. 4.

At block 505, the control system generates one or more latent tensors (e.g., the latent tensors 215 of FIG. 2) by processing the input sensor data using one or more encoders (e.g., the encoders 210 of FIG. 2). That is, if a single (shared) encoder is used, then the control system may generate a single latent tensor based on the input sensor data. If multiple encoders are used (e.g., one for each branch or model of the ensemble), then the control system may generate a respective latent tensor using each respective encoder.

At block 510, the control system selects value(s) for a set of action parameter(s). In some aspects, as discussed above, each action that the system is able to perform may have an associated set of relevant action parameters indicating how to perform the action. For example, for a grasping action, the action parameters may include a grasping orientation (of the end effector), an amount of force with which to grip the object, a direction to move or turn the object after gripping, and the like. In some aspects, as discussed above, the values for continuous action parameters may be discretized into a set of categories or discrete values. For example, for an action parameter corresponding to the end effector orientation (which may have rotation components in multiple dimensions), there may be an infinite (or extremely large) number of possible rotation values. In some aspects, therefore, a defined set of orientations may be defined (e.g., five hundred different possible orientations, out of many more that are technically possible).

In some aspects, at block 510, the control system selects a value or category for each relevant action parameter. In some aspects, the control system may select the set of parameters using any suitable criteria or technique, including randomly or pseudo-randomly. For example, in some aspects, the control system will select each possible combination of action parameters during the method 500 (sequentially or in parallel). In some aspects, at block 510, the control system may generate an action parameter tensor encoding the selected values.

At block 515, the control system generates one or more aggregated latent tensors based on the selected action parameters and/or generated action parameter tensor. For example, if a single shared encoder is used to create a single latent tensor, then the control system may generate an aggregated latent tensor by combining the action parameter tensor with the latent tensor (e.g., using concatenation). In some aspects, if multiple encoders are used (e.g., one for each branch of the ensemble), then the control system may combine the generated action parameter tensor with each respective latent tensor.

At block 520, the control system generates a set of interim affordance maps (e.g., the interim affordance maps 330 of FIG. 3) by processing the aggregated latent tensor(s) using each branch (e.g., each decoder, such as the decoders 325 of FIG. 3) of the ensemble, as discussed above.

At block 525, the control system determines whether there is at least one additional set of action parameters that has not been used to generate an aggregated latent tensor. For example, if there are three hundred unique sets of values, then the control system may determine whether each unique set of values has been evaluated. If there is at least one additional set of values remaining, then the method 500 returns to block 510. If not, then the method 500 continues to block 525. Although the illustrated example depicts an iterative process for conceptual clarity (selecting and evaluating each set of values sequentially), in some aspects, some or all of the alternative parameter values may be evaluated in parallel, as discussed above.

At block 530, the control system optionally aggregates the interim affordance maps. Generally, the control system may use a variety of techniques to aggregate the interim affordance maps. For example, in some aspects, for each set of interim affordance maps that corresponds to the same set of action parameter values (e.g., one from each decoder in the ensemble), the control system may generate an output interim map reflecting (for each pixel or location), the average values from the set, the sum of the values in the set, and the like.

In some aspects, the control system aggregates the interim affordance maps to generate one or more output affordance maps in response to determining that the control system is executing in a runtime inference or robustness phase. For example, as discussed above with reference to Equation 3, the control system may aggregate the interim affordance maps in order to smooth over noise that may be caused by using the output of any single branch of the ensemble. In some aspects, in response to determining that the control system is executing in a training or exploration phase, the control system may refrain from aggregating the interim affordance maps (or may otherwise refrain from using the aggregated affordance maps, if the aggregated affordance maps are still generated). For example, as discussed above with reference to Equation 2, the control system may select and evaluate one of the branches (e.g., one of the interim affordance maps) rather than aggregating the branches during these phases.

The method 500 then terminates (e.g., returning to block 415 of FIG. 4).

### Example Method for Selecting and Performing Actions Using Machine Learning

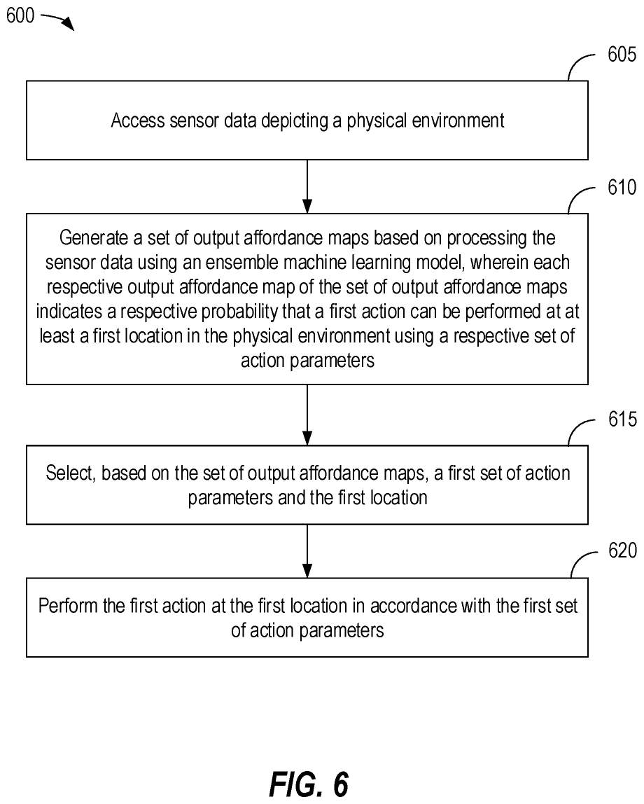

FIG. 6 is a flow diagram depicting an example method 600 for selecting and performing actions using machine learning. In some aspects, the method 600 is performed by a control system, such as the control system 125 of FIG. 1.

At block 605, sensor data depicting a physical environment is accessed.

At block 610, a set of output affordance maps is generated based on processing the sensor data using an ensemble machine learning model, wherein each respective output affordance map of the set of output affordance maps indicates a respective probability that a first action can be performed at at least a first location in the physical environment using a respective set of action parameters.

At block 615, a first set of action parameters and the first location are selected based on the set of output affordance maps.

At block 620, the first action is performed at the first location in accordance with the first set of action parameters.

In some aspects, the method 600 further includes generating a set of uncertainty maps based on the set of output affordance maps, comprising evaluating divergence between the set of output affordance maps, wherein the first set of action parameters and the first location are selected based further on the set of uncertainty maps.

In some aspects, generating the set of output affordance maps comprises: generating a first latent tensor based on processing the sensor data using a first encoder of the ensemble machine learning model, generating a plurality of aggregated latent tensors based on combining each of a plurality of action parameter tensors with the first latent tensor, and generating a first plurality of interim affordance maps based on processing each of the plurality of aggregated latent tensors using a first decoder of the ensemble machine learning model.

In some aspects, generating the set of output affordance maps further comprises: generating a second plurality of interim affordance maps based on a plurality of decoders of the ensemble machine learning model, and generating the set of output affordance maps based on aggregating the first and second pluralities of interim affordance maps.

In some aspects, selecting the first set of action parameters and the first location comprises determining, based on the set of output affordance maps and the set of uncertainty maps, that performing the first action at the first location will maximize predicted success while minimizing uncertainty.

In some aspects, the first decoder is selected, from a plurality of decoders, with at least an element of randomness, and selecting the first set of action parameters and the first location comprises determining, based on the set of output affordance maps and the set of uncertainty maps, that performing the first action at the first location will maximize predicted success while maximizing uncertainty.

In some aspects, each of the plurality of action parameter tensors corresponds to at least one of: (i) an action orientation, (ii) an action force, or (iii) an action direction.

In some aspects, the action orientation comprises a grasp orientation for a robotic grasper.

In some aspects, the method 600 further includes generating a success value based on the performance of the first action at the first location in accordance with the first set of action parameters, and updating one or more parameters of the ensemble machine learning model based on the success value.

In some aspects, updating the one or more parameters of the ensemble machine learning model comprises performing a masked backpropagation operation based on the first location such that one or more other parameters of the ensemble machine learning model corresponding to locations other than the first location are not updated based on the success value.

### Example Processing System for Machine Learning

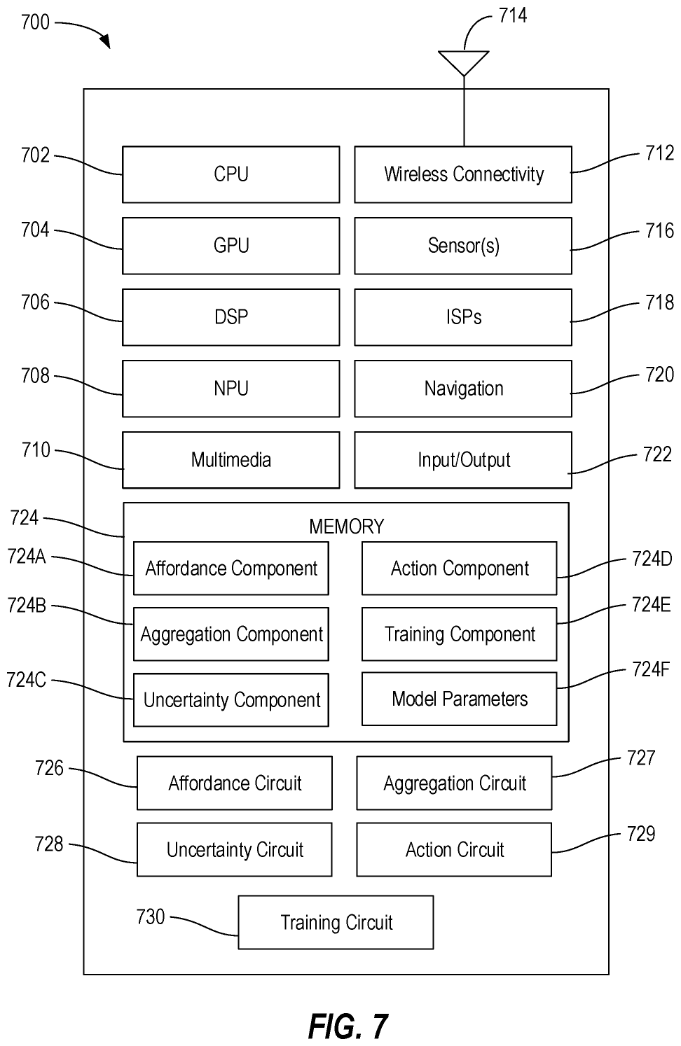

In some aspects, the workflows, techniques, and methods described with reference to FIGS. 1-6 may be implemented on one or more devices or systems. FIG. 7 depicts an example processing system 700 configured to perform various aspects of the present disclosure, including, for example, the techniques and methods described with respect to FIGS. 1-6. In some aspects, the processing system 700 may correspond to a control system, such as the control system 125 of FIG. 1. For example, the processing system 700 may correspond to a device that controls robotic manipulators, trains affordance prediction models, and/or uses affordance prediction models during runtime. Although depicted as a single system for conceptual clarity, in some aspects, as discussed above, the operations described below with respect to the processing system 700 may be distributed across any number of devices or systems.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of memory 724).

The processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and/or other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS), as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes the memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes an affordance component 724A, an aggregation component 724B, an uncertainty component 724C, an action component 724D, and a training component 724E. The memory 724 further includes model parameters 724F for one or more models (e.g., affordance prediction models, such as the machine learning model 207 of FIG. 2, which may include one or more encoders such as the encoder 310 of FIG. 3 and/or one or more decoders such as the decoders 325 of FIG. 3). Although not included in the illustrated example, in some aspects the memory 724 may also include other data, such as a list of available or possible actions that the robotic manipulator(s) can perform, relevant action parameters for each action, possible values for each action parameter, and the like. Though depicted as discrete components for conceptual clarity in FIG. 7, the illustrated components (and others not depicted) may be collectively or individually implemented in various aspects.

The processing system 700 further comprises an affordance circuit 726, an aggregation circuit 727, an uncertainty circuit 728, an action circuit 729, and a training circuit 730. The depicted circuits, and others not depicted, may be configured to perform various aspects of the techniques described herein.

For example, the affordance component 724A and/or the affordance circuit 726 (which may correspond to or use all or a portion of a machine learning model such as the machine learning model 207 of FIG. 2, the encoder 310 of FIG. 3, and/or the decoders 325 of FIG. 3) may be used to generate interim affordance maps (e.g., the interim affordance maps 330 of FIG. 3), as discussed above. For example, the affordance component 724A and/or the affordance circuit 726 may process input sensor data using encoder(s) to generate latent tensor(s), aggregate these latent tensor(s) with action parameter information, and generate interim affordance map(s) using decoder(s).

The aggregation component 724B and/or the aggregation circuit 727 (which may correspond to the aggregation component 335 of FIG. 3) may be used to aggregate interim affordance maps (generated by the affordance component 724A and/or the affordance circuit 726) to generate output affordance maps (e.g., the affordance maps 345 of FIG. 3), as discussed above. For example, the aggregation component 724B and/or the aggregation circuit 727 may generate, for each respective set of action parameter values, a respective aggregated or output affordance map by averaging the corresponding set of interim affordance maps.

The uncertainty component 724C and/or the uncertainty circuit 728 (which may correspond to the uncertainty component 340 of FIG. 3) may be used to generate uncertainty maps (e.g., the uncertainty maps 350 of FIG. 3) based on interim affordance maps (generated by the affordance component 724A and/or the affordance circuit 726), as discussed above. For example, the uncertainty component 724C and/or the uncertainty circuit 728 may, for each respective set of action parameter values, generate a respective uncertainty map by computing the JSD of the corresponding set of interim affordance maps.

The action component 724D and/or the action circuit 729 may be used to generate action instructions (e.g., the actions 130 of FIG. 1) based on interim and/or output affordance maps (generated by the affordance component 724A, the affordance circuit 726, the aggregation component 724B, and/or the aggregation circuit 727) and/or based on uncertainty maps (generated by the uncertainty component 724C and/or the uncertainty circuit 728), as discussed above. For example, the action component 724D and/or the action circuit 729 may use Equation 2 and/or Equation 3 above to select an action (e.g., a location in the environment, such as on an object, where the action should be performed, as well as a set of action parameter values for performing the action) that maximizes the probability of success and/or maximizes or minimizes uncertainty.

The training component 724E and/or the training circuit 730 may be used to evaluate the success of the performed action(s) and/or to update the machine learning ensemble based on the determined success, as discussed above. For example, the training component 724E and/or the training circuit 730 may generate a success value or label based on the results of the action, and update the parameters of the corresponding portion(s) of the machine learning model that were used to select the action (e.g., the specific decoder and/or a subset of parameters for the encoder, such as the subset of parameters that correspond to the location/pixels where the action was performed).

Though depicted as separate components and circuits for clarity in FIG. 7, the affordance circuit 726, the aggregation circuit 727, the uncertainty circuit 728, the action circuit 729, and the training circuit 730 may collectively or individually be implemented in other processing devices of the processing system 700, such as within the CPU 702, the GPU 704, the DSP 706, the NPU 708, and the like.

Generally, the processing system 700 and/or components thereof may be configured to perform the methods described herein.

Notably, in other aspects, elements of the processing system 700 may be omitted, such as where the processing system 700 is a server computer or the like. For example, the multimedia component 710, the wireless connectivity component 712, the sensor processing units 716, the ISPs 718, and/or the navigation processor 720 may be omitted in other aspects. Further, aspects of the processing system 700 may be distributed between multiple devices.

### Example Clauses

Implementation examples are described in the following numbered clauses:

Clause 1: A method, comprising: accessing sensor data depicting a physical environment; generating a set of output affordance maps based on processing the sensor data using an ensemble machine learning model, wherein each respective output affordance map of the set of output affordance maps indicates a respective probability that a first action can be performed at at least a first location in the physical environment using a respective set of action parameters; selecting, based on the set of output affordance maps, a first set of action parameters and the first location; and performing the first action at the first location in accordance with the first set of action parameters.

Clause 2: A method according to Clause 1, further comprising generating a set of uncertainty maps based on the set of output affordance maps, comprising evaluating divergence between the set of output affordance maps, wherein the first set of action parameters and the first location are selected based further on the set of uncertainty maps.

Clause 3: A method according to Clause 2, wherein generating the set of output affordance maps comprises: generating a first latent tensor based on processing the sensor data using a first encoder of the ensemble machine learning model; generating a plurality of aggregated latent tensors based on combining each of a plurality of action parameter tensors with the first latent tensor; and generating a first plurality of interim affordance maps based on processing each of the plurality of aggregated latent tensors using a first decoder of the ensemble machine learning model.

Clause 4: A method according to Clause 3, wherein generating the set of output affordance maps further comprises: generating a second plurality of interim affordance maps based on a plurality of decoders of the ensemble machine learning model; and generating the set of output affordance maps based on aggregating the first and second pluralities of interim affordance maps.

Clause 5: A method according to Clause 4, wherein selecting the first set of action parameters and the first location comprises determining, based on the set of output affordance maps and the set of uncertainty maps, that performing the first action at the first location will maximize predicted success while minimizing uncertainty.

Clause 6: A method according to any of Clauses 3-5, wherein: the first decoder is selected, from a plurality of decoders, with at least an element of randomness, and selecting the first set of action parameters and the first location comprises determining, based on the set of output affordance maps and the set of uncertainty maps, that performing the first action at the first location will maximize predicted success while maximizing uncertainty.

Clause 7: A method according to any of Clauses 3-6, wherein each of the plurality of action parameter tensors corresponds to at least one of: (i) an action orientation, (ii) an action force, or (iii) an action direction.

Clause 8: A method according to Clause 7, wherein the action orientation comprises a grasp orientation for a robotic grasper.

Clause 9: A method according to any of Clauses 1-8, further comprising: generating a success value based on the performance of the first action at the first location in accordance with the first set of action parameters; and updating one or more parameters of the ensemble machine learning model based on the success value.

Clause 10: A method according to Clause 9, wherein updating the one or more parameters of the ensemble machine learning model comprises performing a masked backpropagation operation based on the first location such that one or more other parameters of the ensemble machine learning model corresponding to locations other than the first location are not updated based on the success value.

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory comprising processor-executable instructions; and
one or more processors configured to execute the processor-executable instructions and cause the processing system to:
access sensor data depicting a physical environment;
generate a set of output affordance maps based on processing the sensor data using an ensemble machine learning model, wherein each respective output affordance map of the set of output affordance maps indicates a respective probability that a first action can be performed at at least a first location in the physical environment using a respective set of action parameters;
select, based on the set of output affordance maps, a first set of action parameters and the first location; and
perform the first action at the first location in accordance with the first set of action parameters.

2. The processing system of claim 1, wherein:
the one or more processors are configured to further execute the processor-executable instructions to cause the processing system to generate a set of uncertainty maps based on the set of output affordance maps;
to generate the set of uncertainty maps, the one or more processors are configured to execute the processor-executable instructions to cause the processing system to evaluate divergence between the set of output affordance maps; and
the first set of action parameters and the first location are selected based further on the set of uncertainty maps.

3. The processing system of claim 2, wherein, to generate the set of output affordance maps, the one or more processors are configured to execute the processor-executable instructions to cause the processing system to:
generate a first latent tensor based on processing the sensor data using a first encoder of the ensemble machine learning model;
generate a plurality of aggregated latent tensors based on combining each of a plurality of action parameter tensors with the first latent tensor; and
generate a first plurality of interim affordance maps based on processing each of the plurality of aggregated latent tensors using a first decoder of the ensemble machine learning model.

4. The processing system of claim 3, wherein, to generate the set of output affordance maps, the one or more processors are configured to further execute the processor-executable instructions to cause the processing system to:
generate a second plurality of interim affordance maps based on a plurality of decoders of the ensemble machine learning model; and
generate the set of output affordance maps based on aggregating the first and second pluralities of interim affordance maps.

5. The processing system of claim 4, wherein, to select the first set of action parameters and the first location, the one or more processors are configured to execute the processor-executable instructions to cause the processing system to determine, based on the set of output affordance maps and the set of uncertainty maps, that performing the first action at the first location will maximize predicted success while minimizing uncertainty.

6. The processing system of claim 3, wherein:
the first decoder is selected, from a plurality of decoders, with at least an element of randomness; and
to select the first set of action parameters and the first location, the one or more processors are configured to further execute the processor-executable instructions to cause the processing system to determine, based on the set of output affordance maps and the set of uncertainty maps, that performing the first action at the first location will maximize predicted success while maximizing uncertainty.

7. The processing system of claim 3, wherein each of the plurality of action parameter tensors corresponds to at least one of: (i) an action orientation, (ii) an action force, or (iii) an action direction.

8. The processing system of claim 7, wherein the action orientation comprises a grasp orientation for a robotic grasper.

9. The processing system of claim 1, wherein the one or more processors are configured to further execute the processor-executable instructions to cause the processing system to:
generate a success value based on a performance of the first action at the first location in accordance with the first set of action parameters; and
update one or more parameters of the ensemble machine learning model based on the success value.

10. The processing system of claim 9, wherein, to update the one or more parameters of the ensemble machine learning model, the one or more processors are configured to further execute the processor-executable instructions to cause the processing system to perform a masked backpropagation operation based on the first location such that one or more other parameters of the ensemble machine learning model corresponding to locations other than the first location are not updated based on the success value.

11. A processor-implemented method, comprising:
accessing sensor data depicting a physical environment;
generating a set of output affordance maps based on processing the sensor data using an ensemble machine learning model, wherein each respective output affordance map of the set of output affordance maps indicates a respective probability that a first action can be performed at at least a first location in the physical environment using a respective set of action parameters;
selecting, based on the set of output affordance maps, a first set of action parameters and the first location; and
performing the first action at the first location in accordance with the first set of action parameters.

12. The processor-implemented method of claim 11, further comprising generating a set of uncertainty maps based on the set of output affordance maps, comprising evaluating divergence between the set of output affordance maps, wherein the first set of action parameters and the first location are selected based further on the set of uncertainty maps.

13. The processor-implemented method of claim 12, wherein generating the set of output affordance maps comprises:
generating a first latent tensor based on processing the sensor data using a first encoder of the ensemble machine learning model;
generating a plurality of aggregated latent tensors based on combining each of a plurality of action parameter tensors with the first latent tensor; and
generating a first plurality of interim affordance maps based on processing each of the plurality of aggregated latent tensors using a first decoder of the ensemble machine learning model.

14. The processor-implemented method of claim 13, wherein generating the set of output affordance maps further comprises:
generating a second plurality of interim affordance maps based on a plurality of decoders of the ensemble machine learning model; and
generating the set of output affordance maps based on aggregating the first and second pluralities of interim affordance maps.

15. The processor-implemented method of claim 14, wherein selecting the first set of action parameters and the first location comprises determining, based on the set of output affordance maps and the set of uncertainty maps, that performing the first action at the first location will maximize predicted success while minimizing uncertainty.

16. The processor-implemented method of claim 13, wherein:
the first decoder is selected, from a plurality of decoders, with at least an element of randomness; and
selecting the first set of action parameters and the first location comprises determining, based on the set of output affordance maps and the set of uncertainty maps, that performing the first action at the first location will maximize predicted success while maximizing uncertainty.

17. The processor-implemented method of claim 13, wherein each of the plurality of action parameter tensors corresponds to at least one of: (i) an action orientation, (ii) an action force, or (iii) an action direction.

18. The processor-implemented method of claim 17, wherein the action orientation comprises a grasp orientation for a robotic grasper.

19. The processor-implemented method of claim 11, further comprising:
generating a success value based on a performance of the first action at the first location in accordance with the first set of action parameters; and
updating one or more parameters of the ensemble machine learning model based on the success value.

20. The processor-implemented method of claim 19, wherein updating the one or more parameters of the ensemble machine learning model comprises performing a masked backpropagation operation based on the first location such that one or more other parameters of the ensemble machine learning model corresponding to locations other than the first location are not updated based on the success value.
